(19) United States
(12) Patent Application Publication
(10) Pub. No.: US 2024/0342919 A1
(43) Pub. Date: Oct. 17, 2024

(54) DEVICE FOR TEACHING POSITION AND POSTURE FOR ROBOT TO GRASP WORKPIECE, ROBOT SYSTEM, AND METHOD

(71) Applicant: Fanuc Corporation, Yamanashi (JP)

(72) Inventor: Toshiyuki Ando, Minamitsuru-gun, Yamanashi (JP)

(73) Assignee: Fanuc Corporation, Yamanashi (JP)

(21) Appl. No.: 18/294,752

(22) PCT Filed: Aug. 20, 2021
(86) PCT No.: PCT/JP2021/030660

§ 371 Date: Feb. 2, 2024

(51) Int. Cl. B25J 9/16; B25J 19/02

(52) U.S. Cl. CPC B25J 9/1697; B25J 9/1669; B25J 19/023

(57) ABSTRACT

A device includes: an image data acquisition unit that acquires, when a robot is grasping a workpiece by a hand, image data of the workpiece imaged by a visual sensor disposed at a known position on a control coordinate system; a workpiece position acquisition unit that acquires workpiece position data indicating a position and a posture of the workpiece on the basis of the image data; a hand position acquisition position that acquires hand position data indicating a position and a posture of the hand obtained when the visual sensor has imaged the image data; and a teaching position acquisition unit that acquires, on the basis of the workpiece position data and the hand position data, teaching position data indicating a positional relationship between the hand and the workpiece obtained when the visual sensor has imaged the image data.

### CROSS REFERENCE TO RELATED APPLICATIONS

This is the U.S. National Phase application of PCT/JP2021/030660, filed Aug. 20, 2021, the disclosure of this application being incorporated herein by reference in its entirety.

### FIELD OF THE INVENTION

The present disclosure relates to a device, a robot system, and a method of teaching the position and orientation at which a robot grips a workpiece.

### BACKGROUND OF THE INVENTION

A known robot system performs an operation to cause a robot to grip a workpiece with a hand, based on image data imaged by a vision sensor (e.g., PTL 1).

### PATENT LITERATURE

PTL 1: JP 2016-209979 A

### SUMMARY OF THE INVENTION

In the related art, there is a demand for a technique that enables to teach a robot a position with high accuracy at which a hand grips a workpiece.

In one aspect of the present disclosure, a device that teaches a position and orientation at which a robot grips a workpiece with a hand in a control coordinate system for controlling the robot includes: an image data acquisition unit that acquires image data of the workpiece imaged by a vision sensor arranged at a known position in the control coordinate system when the robot grips the workpiece with the hand; a workpiece position acquisition unit that acquires workpiece position data, which indicates a position and orientation of the workpiece in the control coordinate system when the vision sensor images the image data, based on the image data; a hand position acquisition unit that acquires hand position data, which indicates a position and orientation of the hand in the control coordinate system when the vision sensor images the image data; and a teaching position acquisition unit that acquires teaching position data, which indicates a positional relationship between the hand and the workpiece in the control coordinate system when the vision sensor images the image data, based on the workpiece position data and the hand position data.

In another aspect of the present disclosure, a method of teaching a position and orientation at which a robot grips a workpiece with a hand in a control coordinate system for controlling the robot includes: acquiring, by a processor, image data of the workpiece imaged by a vision sensor arranged at a known position in the control coordinate system when the robot grips the workpiece with the hand; acquiring, by the processor, workpiece position data indicating a position and orientation of the workpiece in the control coordinate system when the vision sensor images the image data, based on the image data; acquiring, by the processor, hand position data indicating a position and orientation of the hand in the control coordinate system, when the vision sensor images the image data; and acquiring, by the processor, teaching position data indicating a positional relationship between the hand and the workpiece in the control coordinate system when the vision sensor images the image data, based on the workpiece position data and the hand position data.

By acquiring teaching position data based on the image data imaged when the operator causes the hand to actually grip the workpiece at the gripping position that the operator wants to teach, the gripping position that the operator wants to teach can be taught to the robot with high accuracy.

### BRIEF DESCRIPTION OF DRAWINGS

FIG. 1 is a perspective view of a robot system according to an embodiment.

FIG. 2 is a block diagram of the robot system illustrated in FIG. 1.

FIG. 3 is an enlarged view of a hand illustrated in FIG. 1.

FIG. 4 is a diagram of a workpiece according to an embodiment.

FIG. 5 illustrates a state in which the hand illustrated in FIG. 3 grips the workpiece illustrated in FIG. 4.

FIG. 6 is an example of image data in which a vision sensor illustrated in FIG. 1 images the workpiece gripped by the hand.

FIG. 7 schematically illustrates a state in which a workpiece model is applied to the image data illustrated in FIG. 6.

FIG. 8 is a flowchart illustrating an example of a method of teaching a robot the position and orientation to grip a workpiece by the hand in the robot system illustrated in FIG. 1.

### DETAILED DESCRIPTION OF EMBODIMENTS OF THE INVENTION

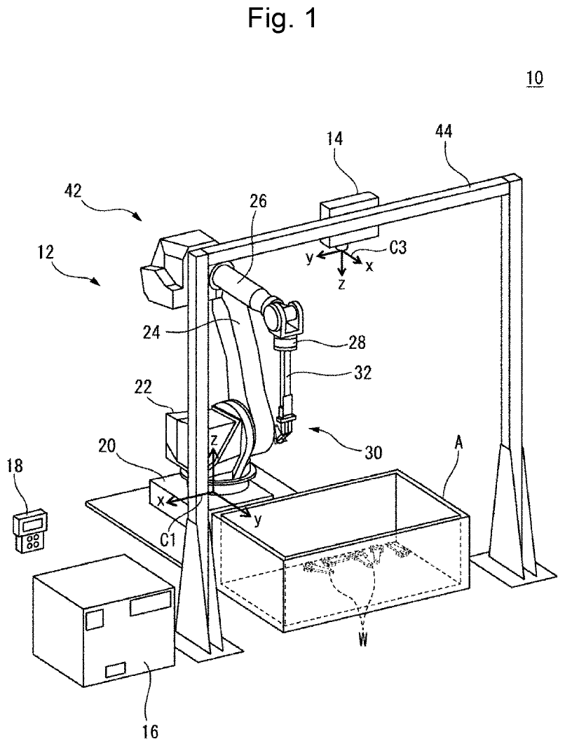

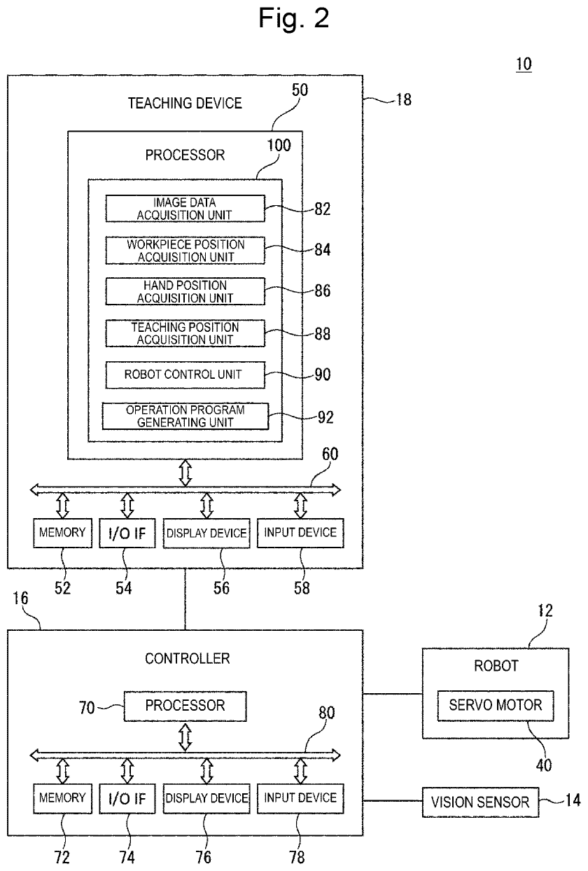

Embodiments of the present disclosure are described in detail below based on the drawings. In the various embodiments described below, the same reference signs are given to the same elements and redundant descriptions are omitted. First, a robot system 10 according to an embodiment will be described with reference to FIGS. 1 and 2. The robot system 10 performs the work of picking up the workpieces W that are stacked in pieces in a container A and is provided with a robot 12, a vision sensor 14, a controller 16, and a teaching device 18.

In the present embodiment, the robot 12 is a vertical articulated robot and includes a robot base 20, a swivel body 22, a lower arm 24, an upper arm 26, a wrist 28, and a hand 30. The robot base 20 is secured on the floor of a work cell. The swivel body 22 is provided on the robot base 20 so as to be rotatable around the vertical shaft. The lower arm 24 is provided at the swivel body 22 so as to be rotatable around the horizontal shaft, and the upper arm 26 is rotatably provided at the tip part of the lower arm 24. The wrist 28 is rotatably provided at the tip part of the upper arm 26.

A plurality of servo motors 40 (FIG. 2) are respectively provided at the robot base 20, the swivel body 22, the lower arm 24, the upper arm 26, and the wrist 28. In response to a command from the controller 16, the servo motor 40 rotates each of the swivel body 22, the lower arm 24, the upper arm 26 and the wrist 28 around the drive shaft, thereby operating the robot 12. In this article, the robot base 20, the swivel body 22, the lower arm 24, the upper arm 26, and the wrist 28 are totally referred to as a mechanical part 42 of the robot 12.

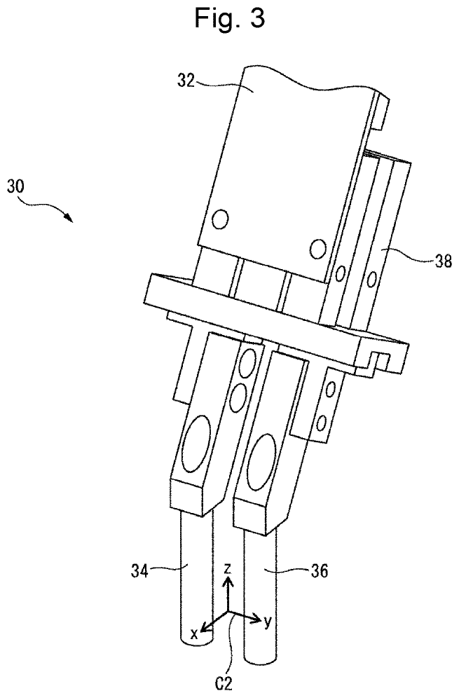

The hand 30 is removably attached to the tip part (so-called wrist flange) of the wrist 28 and moved by the mechanical part 42 of the robot 12. Specifically, as illustrated in FIG. 3, the hand 30 includes a hand arm 32, claw parts 34 and 36, and a claw part drive part 38. The hand arm 32 is coupled at its base end to the tip part of the wrist 28.

The claw parts 34 and 36 are openably and closably provided at the tip part of the hand arm 32. In the present embodiment, each of the claw parts 34 and 36 is a cylindrical rod member extending in a straight line. The claw part drive part 38 includes, for example, a pneumatic or hydraulic cylinder or a servo motor to open and close the claw parts 34 and 36 in response to commands from the controller 16. The hand 30 can grip and release the workpiece W by opening and closing the claw parts 34 and 36.

Referring again to FIGS. 1 and 2, the vision sensor 14 images the workpiece W. Specifically, the vision sensor 14 is fixed at a retention frame 44. The retention frame 44 is fixed on the floor of the work cell and arranges the vision sensor 14 stationary in a position above the container A.

In the present embodiment, the vision sensor 14 is a three-dimensional vision sensor including an image sensor (CMOS, CCD, or the like) and an optical lens (collimating lens, focusing lens, or the like) that guides the subject image to the image sensor and is configured to image the subject along a visual line direction VL and measure the distance d to the subject image.

The teaching device 18 teaches the robot 12 to grip the workpieces W that are stacked in pieces in the container A with the hand 30. Specifically, the teaching device 18 is a portable computer such as a teaching pendant or a tablet-type terminal device and includes a processor 50, a memory 52, an I/O interface 54, a display device 56, and an input device 58. The processor 50 includes a CPU or a GPU, is communicably connected to the memory 52, the I/O interface 54, the display device 56, and the input device 58 via a bus 60, and performs arithmetic processing to achieve the teaching function described below while communicating with these components.

The memory 52 includes a RAM or a ROM and temporarily or permanently stores various data. The I/O interface 54 includes, for example, an Ethernet (trade name) port, a USB port, an optical fiber connector, or an HDMI (trade name) terminal and communicates data wiredly or wirelessly with an external device under a command from the processor 50.

The display device 56 includes a liquid crystal display or an organic EL display and displays various kinds of data visually under a command from the processor 50. The input device 58 includes a push button, a keyboard, a mouse, or a touch panel and accepts input data from an operator.

The teaching device 18 is configured to send a command to the robot 12 via the controller 16 in response to input data to the input device 58 and to allow the robot 12 to jog in accordance with the command. The display device 56 and the input device 58 may be integrated into the housing of the teaching device 18 or may be externally attached to the housing separately from the housing of the teaching device 18.

The controller 16 controls the operation of the robot 12 and the vision sensor 14. Specifically, the controller 16 is a computer with a processor 70, a memory 72, an I/O interface 74, a display device 76, and an input device 78. The configurations and functions of the processor 70, the memory 72, the I/O interface 74, the display device 76, and the input device 78 are the same as those of the processor 50, the memory 52, the I/O interface 54, the display device 56, and the input device 58, which are described above, so that overlapping descriptions are omitted.

The processor 70 is communicably connected to the memory 72, the I/O interface 74, the display device 76, and the input device 78 via a bus 80 and, while communicating with these components, performs arithmetic processing to achieve the function of operating the robot 12 and the vision sensor 14. The I/O interface 54 of the teaching device 18, the respective servo motors 40 of the robot 12, and the vision sensor 14 are connected to the I/O interface 74, and the processor 70 communicates with these components through the I/O interface 74.

As illustrated in FIG. 1, a robot coordinate system C1 is set in the mechanical part 42 of the robot 12. The robot coordinate system C1 is a control coordinate system C for automatically controlling the operation of the robot 12 gripping the workpiece W by the hand 30. In the present embodiment, the robot coordinate system C1 is set with respect to the mechanical part 42 such that an origin of the robot coordinate system C1 is located at the center of the robot base 20 and a z-axis of the robot coordinate system C1 coincides with the rotation axis of the swivel body 22.

On the other hand, a tool coordinate system C2 is set at the hand 30 of the robot 12 as illustrated in FIG. 3. The tool coordinate system C2 is the control coordinate system C, which determines the position and orientation of the hand 30 in the robot coordinate system C1. In the present embodiment, the tool coordinate system C2 is set with respect to the hand 30 such that an origin of the tool coordinate system C2 is located at the intermediate position between the claw parts 34 and 36, a y-axis direction of the tool coordinate system C2 is parallel to the opening and closing direction of the claw parts 34 and 36, and a z-axis direction of the tool coordinate system C2 is parallel to the extending direction of each claw part 34 and 36.

The positional relationship between the tool coordinate system C2 and the robot coordinate system C1 is known, and the coordinates of the tool coordinate system C2 and the coordinates of the robot coordinate system C1 can be mutually transformed via a known transformation matrix M1 (e.g., the homogeneous transformation matrix). Thus, the origin position and the direction of each axis of the tool coordinate system C2 in the robot coordinate system C1 are represented as coordinates (X_{RT}, Y_{RT}, Z_{RT}, W_{RT}, P_{RT}, R_{RT}) of the robot coordinate system C1. Here, the coordinates (X_{RT}, Y_{RT}, Z_{RT}) indicate the origin position of the tool coordinate system C2 in the robot coordinate system C1, and the coordinates (W_{RT}, P_{RT}, R_{RT}) indicate the direction (so-called yaw, pitch, roll) of each axis of tool coordinate system C2 in the robot coordinate system C1.

When the hand 30 is positioned at a predetermined position and orientation by the mechanical part 42 of the robot 12, the processor 70 of the controller 16 first sets the tool coordinate system C2 representing the predetermined position and orientation in the robot coordinate system C1. Subsequently, the processor 70 generates a command to each of the servo motors 40 to arrange the hand 30 at the position and orientation determined by the set tool coordinate system C2 and moves the hand 30 by operating the mechanical part 42 in response to the command. Thus, the processor 70 can position the hand 30 at the predetermined position and orientation by the operation of the mechanical part 42 in the robot coordinate system C1.

As illustrated in FIG. 1, a sensor coordinate system C3 is set to the vision sensor 14. The sensor coordinate system C3 is the control coordinate system C that determines the position and orientation (i.e., visual line direction VL) of the vision sensor 14 in the robot coordinate system C1, and also determines the coordinates of each pixel in the image data (or, an image sensor) imaged by the vision sensor 14. In the present embodiment, the sensor coordinate system C3 is set with respect to the vision sensor 14 such that an origin of the sensor coordinate system C3 is located at the center of the image sensor and a z-axis direction of the sensor coordinate system C3 coincides with the visual line direction VL of the vision sensor 14.

Here, in the present embodiment, the vision sensor 14 is disposed at a known position of the robot coordinate system C1 by the retention frame 44. More specifically, the positional relationship between the sensor coordinate system C3 and the robot coordinate system C1 is known by calibration, and the coordinates of the sensor coordinate system C3 and the coordinates of the robot coordinate system C1 can be mutually transformed via a known transformation matrix M2 (e.g., the homogeneous transformation matrix). Thus, the position and orientation (i.e., the origin position and the direction of each axis of the sensor coordinate system C3) of the vision sensor 14 in the robot coordinate system C1 are known.

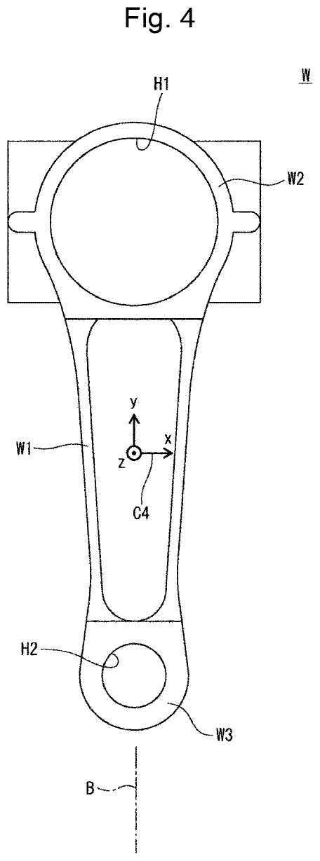

In an actual work line, the processor 70 of the controller 16 images the workpieces W, which are stacked in pieces in the container A, with the vision sensor 14 and, based on imaged image data ID, executes the operation to cause the robot 12 to grip the workpiece W with the hand 30 and pick the workpiece W up from the container A. FIG. 4 illustrates an example of the workpiece W.

In the example illustrated in FIG. 4, the workpiece W is, for example, a connecting rod for an automobile and includes a shaft W1, a large ring W2, and a small ring W3. The shaft W1 extends straight along an axis B. The large ring W2 is fixed to one end of the shaft W1 and has a through hole H1. On the other hand, the small ring W3 is fixed to the other end of the shaft W1 and has a through hole H2.

A workpiece coordinate system C4 is set at the workpiece W to perform the operation of the robot 12 gripping the workpiece W with the hand 30. The workpiece coordinate system C4 is a control coordinate system C that determines the position and orientation of the workpiece W in the robot coordinate system C1. In the present embodiment, the workpiece coordinate system C4 is set with respect to the workpiece W such that an origin of the workpiece coordinate system C4 is located at the center of the shaft W1, a y-axis of the workpiece coordinate system C4 is parallel (or coincides) with the axis B, and a z-axis of the workpiece coordinate system C4 is parallel to the central axes of the through holes H1 and H2.

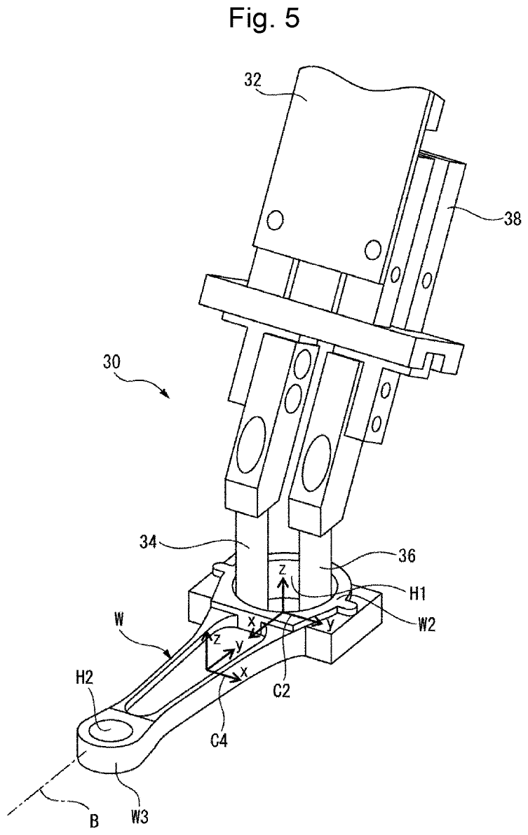

FIG. 5 illustrates an example of a state in which the robot 12 grips the workpiece W with the hand 30. In the example illustrated in FIG. 5, the hand 30 grips the large ring W2 of the workpiece W with the claw parts 34 and 36 by opening the claw parts 34 and 36 inserted into the through hole H1. To cause the robot 12 to perform the operation of gripping the workpiece W as illustrated in FIG. 5, teaching the position and orientation at which the robot 12 grips the workpiece W with the hand 30 is required.

The following describes a method of teaching the robot 12 an operation for gripping the workpiece W in the robot system 10. First, an operator causes the hand 30 of the robot 12 to grip the workpiece W at a gripping position that the operator wants to teach. For example, the operator controls the teaching device 18 to jog the robot 12, so that the workpiece W is gripped by the hand 30.

More specifically, the operator, while viewing the display device 56 of the teaching device 18, operates the input device 58 to move the hand 30 by the mechanical part 42 of the robot 12 and inserts the closed claw parts 34 and 36 into the through hole H1 of the workpiece W arranged at a predetermined storage location. Subsequently, the operator grips the workpiece W by operating the input device 58 to open the claw parts 34 and 36 and pressing the claw parts 34 and 36 against the inner wall surface of the through hole H1.

At this time, the operator causes the robot 12 to jog so that the hand 30 grips the workpiece W at the gripping position that the operator wants to teach. Hereafter, a case in which the operator causes the hand 30 to grip the workpiece W at the gripping position illustrated in FIG. 5, will be described. Subsequently, the operator operates the input device 58 to jog the robot 12 and moves the hand 30 by the mechanical part 42 of the robot 12 so that the workpiece W gripped by the hand 30 is within the field of view of the vision sensor 14.

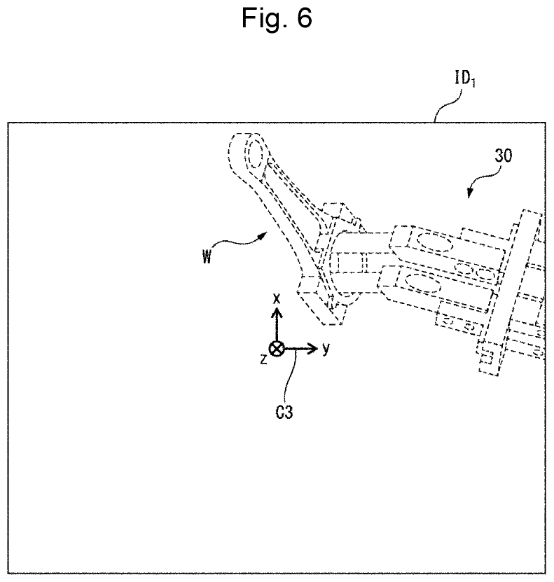

Subsequently, the operator operates the input device 58 to cause the vision sensor 14 to image the workpiece W gripped by the hand 30. The vision sensor 14 receives an imaging command from the teaching device 18 via the controller 16 and images image data ID₁ of the workpiece W. An example of the image data ID₁ is illustrated in FIG. 6.

In the example illustrated in FIG. 6, visual features (edge, hole, apex, or the like) of the workpiece W and the hand 30 are displayed as a three-dimensional point cloud in the image data ID₁. Each point constituting the three-dimensional point cloud includes the information of the above-described distance d and can be represented as three-dimensional coordinates (X_{S}, Y_{S}, Z_{S}) in the sensor coordinate system C3. That is, in the present embodiment, the image data ID₁ is three-dimensional image data.

The processor 50 of the teaching device 18 acquires the image data ID₁ from the vision sensor 14 through the controller 16 and the I/O interface 54. Thus, in the present embodiment, the processor 50 serves as an image data acquisition unit 82 (FIG. 2) that acquires the image data ID of the workpiece W imaged by the vision sensor 14 when the robot 12 grips the workpiece W with the hand 30.

Subsequently, based on the image data ID₁, the processor 50 acquires the workpiece position data WPD₁ indicating the position and orientation of the workpiece W in the robot coordinate system C1 when the vision sensor 14 images the image data ID₁. Specifically, the processor 50 first obtains a workpiece model WM which models the workpiece W. This workpiece model WM is, for example, a three-dimensional CAD model, which is stored in advance in the memory 52.

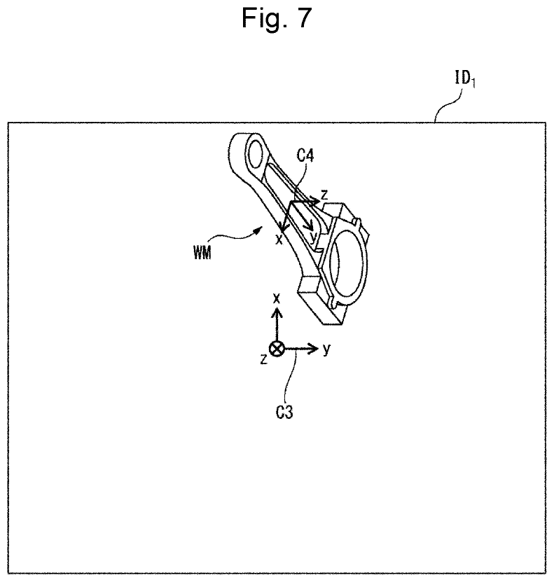

The processor 50 analyzes the three-dimensional point cloud image of the workpiece W shown in the image data ID₁ using a predetermined pattern matching parameter and arranges the workpiece model WM in the image data ID₁ in a simulated manner so as to match the workpiece W shown in the image data ID₁. FIG. 7 illustrates the workpiece model WM arranged in the image data ID₁ in a simulated manner. In FIG. 7, the image of the hand 30 is omitted for ease of understanding.

Subsequently, the processor 50 sets the workpiece coordinate system C4 in the positional relationship illustrated in FIG. 4 with respect to the workpiece model WM arranged in the image data ID₁. This workpiece coordinate system C4 indicates the position and orientation of the workpiece W shown in the image data ID₁ in the sensor coordinate system C3 and is represented as coordinates Q_{SW_1} (X_{SW_1}, Y_{SW_1}, Z_{SW_1}, W_{SW_1}, P_{SW_1}, R_{SW_1}) (first coordinates) in the sensor coordinate system C3.

Here, the coordinates (X_{SW_1}, Y_{SW_1}, Z_{SW_1}) indicate the origin position of the workpiece coordinate system C4 in the sensor coordinate system C3, and the coordinates (W_{SW_1}, P_{SW_1}, R_{SW_1}) indicate the direction (so-called yaw, pitch, roll) of each axis of the workpiece coordinate system C4 in the sensor coordinate system C3. The processor 50 acquires the coordinates Q_{SW_1} of the workpiece coordinate system C4 in the sensor coordinate system C3 as data indicating the position and orientation, in the sensor coordinate system C3, of the workpiece W shown in the image data ID₁.

Subsequently, the processor 50 uses the above-described transformation matrix M2 to transform the acquired coordinates Q_{SW_1} into the robot coordinate system C1, thereby obtaining coordinates Q_{RW_1} (X_{RW_1}, Y_{RW_1}, Z_{RW_1}, W_{RW_1}, P_{RW_1}, R_{RW_1}) (second coordinates) of the workpiece coordinate system C4 illustrated in FIG. 7, in the robot coordinate system C1. These coordinates Q_{RW_1} are data indicating the position and orientation, in the robot coordinate system C1, of the workpiece W (specifically, the workpiece model WM in FIG. 7) shown in the image data ID₁.

The processor 50 acquires these coordinates Q_{RW_1} as workpiece position data WPD₁. Thus, in the present embodiment, the processor 50 serves as a workpiece position acquisition unit 84 (FIG. 2) that acquires workpiece position data WPD₁ (coordinates Q_{RW_1}) based on the image data ID₁.

On the other hand, the processor 50 acquires hand position data HPD₁ indicating the position and orientation of the hand 30 in the robot coordinate system C1 when the vision sensor 14 images the image data ID₁. Specifically, the processor 50 acquires, as the hand position data HPD₁, the coordinates Q_{RT_1} (X_{RT_1}, Y_{RT_1}, Z_{RT_1}, W_{RT_1}, P_{RT_1}, R_{RT_1}) (third coordinates) of the tool coordinate system C2 in the robot coordinate system C1 when the vision sensor 14 images the image data ID₁. Thus, in the present embodiment, the processor 50 serves as a hand position acquisition unit 86 (FIG. 2) that acquires the hand position data HPD₁ (coordinates Q_{RT_1}).

Subsequently, based on the workpiece position data WPD₁ and the hand position data HPD₁ that are acquired, the processor 50 acquires teaching position data TPD₁ indicating the positional relationship between the hand 30 and the workpiece W in the control coordinate system C when the vision sensor 14 images the image data ID₁.

As an example, the processor 50 transforms the coordinates Q_{RW_1} as the workpiece position data WPD₁ into the coordinates of the tool coordinate system C2 represented by the coordinates Q_{RT_1} as the hand position data HPD₁, based on coordinates Q_{RW_1} acquired as the workpiece position data WPD₁ and the coordinates Q_{RT_1} acquired as the hand position data HPD₁. Since the positional relationship between the tool coordinate system C2 and the workpiece coordinate system C4 in the robot coordinate system C1 is known by the coordinates Q_{RW_1} and Q_{RT_1}, the coordinates Q_{RW_1} of the workpiece coordinate system C4 in the robot coordinate system C1 can be transformed into the tool coordinate system C2.

With this coordinate transformation, the processor 50 acquires the coordinates Q_{TW_1} (X_{TW_1}, Y_{TW_1}, Z_{TW_1}, W_{TW_1}, P_{TW_1}, R_{TW_1}) of the workpiece coordinate system C4 in the tool coordinate system C2 when the vision sensor 14 images the image data ID₁. These coordinates Q_{TW_1} are data indicating the position and orientation (i.e., the origin position and direction of each axis of the workpiece coordinate system C4) of the workpiece W relative to the hand 30 (i.e., tool coordinate system C2) when the vision sensor 14 images the image data ID₁. The processor 50 acquires these coordinates Q_{TW_1} as the teaching position data TPD₁.

As another example, based on the coordinates Q_{RW_1} as the workpiece position data WPD₁ and the coordinates Q_{RT_1} as the hand position data HPD₁, the processor 50 transforms the coordinates Q_{RT_1} as the hand position data HPD₁ into the coordinates of the workpiece coordinate system C4 represented by the coordinates Q_{RW_1} as the workpiece position data WPD₁. Thus, the processor 50 acquires coordinates Q_{WT_1} (X_{WT_1}, Y_{WT_1}, Z_{WT_1}, W_{WT_1}, P_{WT_1}, R_{WT_1}) of the tool coordinate system C2 in the workpiece coordinate system C4 when the vision sensor 14 images the image data ID₁.

These coordinates Q_{WT_1} are data indicating the position and orientation (i.e., the origin position and the direction of each axis of the tool coordinate system C2) of the hand 30 relative to the workpiece W (i.e., the workpiece coordinate system C4) when the vision sensor 14 images the image data ID₁. The processor 50 acquires these coordinates Q_{WT_1} as teaching position data TPD₁.

Thus, in the present embodiment, the processor 50 serves as a teaching position acquisition unit 88 (FIG. 2), which acquires teaching position data TPD₁ (coordinates Q_{TW_1}, coordinates Q_{WT_1}) indicating the positional relationship between the hand 30 and the workpiece W in the control coordinate system C (tool coordinate system C2, workpiece coordinate system C4) when the vision sensor 14 images the image data ID₁, based on the workpiece position data WPD₁ and the hand position data HPD₁.

After acquiring the teaching position data TPD₁, the operator operates the input device 58 to change the orientation of the hand 30 while gripping the workpiece W by the operation of the mechanical part 42 of the robot 12. For example, the operator operates the input device 58 to enter input data for rotating the hand 30 by a predetermined angle θ (e.g., 10 degrees) around the x-axis, y-axis, or z-axis of the tool coordinate system C2, which is set in the robot coordinate system C1 at this point.

Alternatively, the operator may enter input data to rotate the hand 30 by a predetermined angle θ about the x-axis, y-axis, or z-axis of the workpiece coordinate system C4, which is set in the robot coordinate system C1 at this point. For example, when the y-axis of the workpiece coordinate system C4 coincides with the axis B of the workpiece W, the operator may enter input data to rotate the hand 30 around the y-axis (i.e., axis B) of the workpiece coordinate system C4.

In response to input data from the operator, the processor 50 sends a command to the servo motors 40 of the robot 12 via the controller 16 to operate the mechanical part 42 so as to change the orientation of the hand 30 gripping the workpiece W. Thus, in the present embodiment, the processor 50 serves as a robot control unit 90 (FIG. 2) that operates the robot 12 so as to change the orientation of the hand 30.

When the orientation of the hand 30 is changed, the operator operates the input device 58 to cause the vision sensor 14 to image the workpiece W gripped by the hand 30, and the processor 50, which serves as the image data acquisition unit 82, acquires image data ID₂ of the workpiece W. Subsequently, the processor 50 serves as the workpiece position acquisition unit 84 and acquires the coordinates Q_{SW_2} (X_{SW_2}, Y_{SW_2}, Z_{SW_2}, W_{SW_2}, P_{SW_2}, R_{SW_2}) (first coordinates) of the workpiece coordinate system C4 in the sensor coordinate system C3 by applying the workpiece model WM to the image data ID₂ by the above-described method.

Subsequently, the processor 50 serves as the workpiece position acquisition unit 84 and acquires the coordinates Q_{RW_2} (X_{RW_2}, Y_{RW_2}, Z_{RW_2}, W_{RW_2}, P_{RW_2}, R_{RW_2}) (second coordinates) of the workpiece coordinate system C4 in the robot coordinate system C1, as workpiece position data WPD₂ when the image data ID₂ is imaged, by transforming the acquired coordinates Q_{SW_2} into the robot coordinate system C1 by the above-described method.

In addition, the processor 50 serves as the hand position acquisition unit 86 and acquires the coordinates Q_{RT_2} (X_{RT_2}, Y_{RT_2}, Z_{RT_2}, W_{RT_2}, P_{RT_2}, R_{RT_2}) (third coordinates) of the tool coordinate system C2 in the robot coordinate system C1 as hand position data HPD₂ during imaging of the image data ID₂ by the above-described method.

Subsequently, the processor 50 serves as the teaching position acquisition unit 88 and acquires the coordinates Q_{TW_2} (X_{TW_2}, Y_{TW_2}, Z_{TW_2}, W_{TW_2}, P_{TW_2}, R_{TW_2}) of the workpiece coordinate system C4 in the tool coordinate system C2 or the coordinates Q_{WT_2} (X_{WT_2}, Y_{WT_2}, Z_{WT_2}, W_{WT_2}, P_{WT_2}, R_{WT_2}) of the tool coordinate system C2 in the workpiece coordinate system C4, as the teaching position data TPD₂ during imaging of the image data ID₂ by the above-described method.

In this way, the operator operates the input device 58 to repeatedly change the orientation of the hand 30, the vision sensor 14 images the workpiece W gripped by the hand 30 each time the orientation of the hand 30 is changed, and the processor 50 serves as the image data acquisition unit 82 to acquire a plurality of pieces of image data IDₙ (n=1, 2, 3, . . . ) imaged by the vision sensor 14.

The processor 50 serves as the workpiece position acquisition unit 84 to acquire workpiece position data WPDₙ: coordinates Q_{RW_n} (X_{RW_n}, Y_{RW_n}, Z_{RW_n}, W_{RW_n}, P_{RW_n}, R_{RW_n}) when each image data IDₙ is imaged, by the above-described method and serves as the hand position acquisition unit 86 to acquire hand position data HPDₙ: coordinates Q_{RT_n} (X_{RT_n}, Y_{RT_n}, Z_{RT_n}, W_{RT_n}, P_{RT_n}, R_{RT_n}) when each image data IDₙ is imaged, by the above-described method.

Subsequently, the processor 50 serves as the teaching position acquisition unit 88 and acquires teaching position data TPDₙ: coordinates Q_{TW_n} (X_{TW_n}, Y_{TW_n}, Z_{TW_n}, W_{TW_n}, P_{TW_n}, R_{TW_n}) or coordinates Q_{WT_n} (X_{WT_n}, Y_{WT_n}, Z_{WT_n}, W_{WT_n}, P_{WT_n}, R_{WT_n}) when each image data IDₙ is imaged, based on the corresponding workpiece position data WPDₙ(coordinates Q_{RW_n}) and the corresponding hand position data HPDₙ(coordinates Q_{RT_n}) that are acquired, by the above-described method. Thus, the processor 50 can acquire a plurality of pieces of teaching position data TPDₙ corresponding to the various orientations of the hand 30 and the workpiece W.

Subsequently, the processor 50 serves as the teaching position acquisition unit 88 and obtains, based on the plurality of pieces of teaching position data TPDₙ that are acquired, new teaching position data TPD₀ that is to be used in the operation to cause the robot 12 to actually grip the workpiece W with the hand 30. The following describes how the processor 50 obtains new teaching position data TPD₀ upon acquiring the coordinates Q_{TW_n} (X_{TW_n}, Y_{TW_n}, Z_{TW_n}, W_{TW_n}, P_{TW_n}, R_{TW_n}) of the tool coordinate system C2 as the teaching position data TPDₙ.

First, for each of the plurality of coordinates Q_{TW_n}, the processor 50 performs processing PR1, which excludes coordinates outside of the predetermined allowable range. Specifically, the processor 50 performs the processing PR1, which excludes coordinates outside of the allowable range, for coordinates (X_{TW_n}, Y_{TW_n}, Z_{TW_n}) representing positions in the coordinates Q_{TW_n}.

As an example, the processor 50 obtains the distance Δₙ from the origin of the tool coordinate system C2, from the equation: Δₙ=(X_{TW_n}²+Y_{TW_n}²+Z_{TW_n}²)^{1/2}. Subsequently, the processor 50 determines whether or not the obtained distance Δₙ is within a predetermined allowable range [Δₜₕ₁, Δₜₕ₂], and when the distance Δₙ is within the allowable range [Δₜₕ₁, Δₜₕ₂] (i.e., Δₜₕ₁≤Δn≤Δₜₕ₂), the acquired coordinates Q_{TW_n} are registered in the memory 52 as the active coordinates group GRP, while when the distance Δₙ is outside of the allowable range [Δₜₕ₁, Δₜₕ₂] (i.e., Δn<Δₜₕ₁, or Δₜₕ₂<Δⁿ), the acquired coordinates Q_{TW_n} are excluded (or deleted from the memory 52) from the active coordinates group GRP.

As another example, the processor 50 obtains the average coordinates Q_{TW_AV} (X_{TW_AV}, Y_{TW_AV}, Z_{TW_AV}) of the coordinates Q_{TW_n} (X_{TW_n}, Y_{TW_n}, Z_{TW_n}). Specifically, the processor 50 obtains the average coordinates Q_{TW_AV} (X_{TW_AV}, Y_{TW_AV}, Z_{TW_AV}) from the equations: X_{TW_AV}=1/n·Σ(X_{TW_n}), Y_{TW_AV}=1/n·Σ(Y_{TW_n}), and Z_{TW_AV}=1/n·Σ(Z_{TW_n}).

Furthermore, the processor 50 obtains the standard deviation σ_{X}, σ_{Y} and σ_{Z} of the coordinates Q_{TW_n} (X_{TW_n}, Y_{TW_n}, Z_{TW_n}), respectively. For example, the processor 50 obtains the above from the following equations: σ_{X}=(1/n·Σ{X_{TW_n}−X_{TW_AV}})^{1/2}, σ_{Y}=(1/n·Σ{Y_{TW_n}−Y_{TW_AV}})^{1/2}, σ_{Z}=(1/n·Σ{Z_{TW_n}−Z_{TW_AV}})^{1/2}.

Subsequently, for each of the coordinates X_{TW_n}, Y_{TW_n}, and Z_{TW_n} in the coordinates Q_{TW_n}, the processor 50 determines the allowable range using the obtained average and standard deviation a and the predetermined coefficient α (e.g., α is a positive integer) as follows: [X_{TW_AV}−ασ_{X}, X_{TW_AV}+ασ_{X}] (i.e., X_{TW_AV}−ασ_{X}≤X_{TW_n}≤X_{TW_AV}+ασ_{X}), [Y_{TW_AV}−ασ_{Y}, Y_{TW_AV}+ασ_{Y}] (i.e., Y_{TW_AV}−ασ_{Y}≤Y_{TW_n}≤Y_{TW_AV}+ασ_{Y}), and [Z_{TW_AV}−ασ_{Z}, Z_{TW_AV}+ασ_{Z}] (i.e., Z_{TW_AV}−ασ_{Z}≤Z_{TW_n}≤Z_{TW_AV}+ασ_{Z}).

The processor 50 determines whether or not the coordinates X_{TW_n} are within the allowable range [X_{TW_AV}−σ_{X}, X_{TW_AV}+σ_{X}], whether or not the coordinates Y_{TW_n} are within the allowable range [Y_{TW_AV}−σ_{Y}, Y_{TW_AV}+σ_{Y}], and whether or not the coordinates Z_{TW_n} are within the allowable range [Z_{TW_AV}−σ_{Z}, Z_{TW_AV}+σ_{Z}].

Subsequently, the processor 50 registers the acquired coordinates Q_{TW_n} as the active coordinates group GRP when all of the coordinates X_{TW_n}, Y_{TW_n}, and Z_{TW_n} are within the allowable range, while excludes the acquired coordinates Q_{TW_n} from the active coordinates group GRP when at least one of the coordinates X_{TW_n}, Y_{TW_n}, and Z_{TW_n} are outside of the allowable range.

In addition, the processor 50 performs the processing PR1, which excludes the coordinates outside of the allowable range, for the coordinates (W_{TW_n}, P_{TW_n}, R_{TW_n}) representing the orientation in the coordinates Q_{TW_n}. Specifically, the processor 50 first represents the coordinates (W_{TW_n}, P_{TW_n}, R_{TW_n}) indicating the orientation as a 3×3 known matrix M3_{_n}.

In this matrix M3_{_n}, a vector VT1_{_n} represented by three parameters in a first column is a unit vector representing the rotation component around the x-axis of the tool coordinate system C2, a vector VT2_{_n} represented by three parameters in a second column is a unit vector representing the rotation component around the y-axis of the tool coordinate system C2, and a vector VT3_{_n} represented by three parameters in a third column is a unit vector representing the rotation component around the z-axis of the tool coordinate system C2.

For example, the processor 50 obtains the inner product IP1ₙ of the vector VT1_{_n} of the matrix M3_{_n} representing the first coordinates Q_{TW_n} (W_{TW_n}, P_{TW_n}, R_{TW_n}) and the vector VT1_{_n+1} of the matrix M3_{_n+1} representing the second coordinates Q_{TW_n+1} (W_{TW_n+1}, P_{TW_n+1}, R_{TW_n+1}). This inner product IP1ₙ represents an angle φ1 (specifically, cos φ1) between the vector VT1_{_n} and the vector VT1_{_n+1}, that is, the amount of change in the rotation component around the x-axis of the tool coordinate system C2.

The processor 50 also obtains inner product IP3ₙ of the vector VT3_{_n} of the matrix M3_{_n} and the vector VT3_{_n+1} of the matrix M3_{_n+1}. This inner product IP3ₙ represents the angle φ3 (specifically, cos φ3) between the vector VT3_{_n} and the vector VT3_{_n+1}, that is, the amount of change in the rotation component around the z-axis of the tool coordinate system C2.

Subsequently, the processor 50 determines whether or not the obtained inner product IP1ₙ is equal to or more than a predetermined threshold value IP1ₜₕ (IP1ₙ≥IP1ₜₕ), and also determines whether or not the obtained inner product IP3n is equal to or more than a predetermined threshold value IP3ₜₕ (IP3ₙ≥IP3ₜₕ). When IP1ₙ≥IP1ₜₕ and IP3ₙ>IP3ₜₕ, the processor 50 registers both of the acquired first coordinates Q_{TW_n} and second coordinates Q_{TW_n+1} as active coordinates group GRP in the memory 52.

On the other hand, the processor 50 excludes (or deletes from the memory 52) from the active coordinates group GRP, either the acquired first coordinates Q_{TW_n} or the second coordinates Q_{TW_n}+1 when IP1ₙ<IP1ₜₕ or IP3ₙ<IP3ₜₕ. The operator may decide in advance which of the first coordinates Q_{TW_n} and the second coordinates Q_{TW_n+1} are to be excluded.

The processor 50 may obtain the inner product IP1ᵢ of the vector VT1_{_n} of the matrix M3_{_n} representing the first coordinates Q_{TW_n} (W_{TW_n}, P_{TW_n}, R_{TW_n}) and each of the vectors VT1_{_i} (“i” is a positive integer other than “n”) of the matrix M3_1 representing the coordinates Q_{TW_1} (W_{TW_1}, P_{TW_1}, R_{TW_1}) other than the first coordinates Q_{TW_n}. Similarly, the processor 50 may obtain an inner product IP3ᵢ of the vector VT3_{_n} of the matrix M3_{_n} of the first coordinates Q_{TW_n} and each of the vectors VT3_{_i} of the matrix M3_{_i} of the coordinates Q_{TW_i} other than the first coordinates Q_{TW_n}.

Subsequently, the processor 50 may determine whether or not each of the obtained inner products IP1ᵢ is equal to or more than a threshold value IP1ₜₕ (IP1ᵢ≥IP1ₜₕ) and also determines whether or not each of the obtained inner products IP3ᵢ is equal to or more than a threshold value IP3ₜₕ (IP3ᵢ≥IP3ₜₕ). When at least one (or all) of the obtained inner products IP1ᵢ satisfies IP1ᵢ≥IP1ₜₕ and at least one (or all) of the obtained inner products IP3ᵢ satisfies IP3ᵢ≥IP3ₜₕ, the processor 50 may register the acquired first coordinates Q_{TW_n} in the memory 52 as the active coordinates group GRP.

On the other hand, the processor 50 may exclude the obtained first coordinates Q_{TW_n} from the active coordinates group GRP when all (or at least one) of the obtained inner products IP1ᵢ are IP1ᵢ<IP1ₜₕ, or when all (or at least one) of the obtained inner products IP3ᵢ are IP3ᵢ<IP3ₜₕ. The processor 50 may repeat such processing PR1 for all of the acquired coordinates Q_{TW_n}.

Alternatively, the processor 50 obtains the resultant vector VT1_{R}=Σ(VT1_{_n}) for the vector VT1_{_1}, VT1_{_2}, VT1_{_3}, . . . VT1_{_n} and obtains the inner product IP1_{R_n} of the resultant vector VT1_{R} and each vector VT1_{_n}. Subsequently, the processor 50 determines whether or not the obtained inner product IP1_{R_n} is equal to or more than a predetermined threshold value IP1_{Rth} (IP1_{R_n}≥IP1_{Rth}). The processor 50 registers coordinates Q_{TW_n} as the active coordinates group GRP in the memory 52 when IP1_{R_n}≥IP1_{Rth}, while excludes (or deletes from the memory 52) the coordinates Q_{TW_n} from the active coordinates group GRP when IP1_{R_n}≤IP1_{Rth}.

Similarly to the vector VT1_{_n}, the processor 50 can also determine the coordinates Q_{TW_n} to be excluded from the active coordinates group GRP for the vector VT2_{_n} by obtaining the resultant vector VT2_{R}=Σ(VT2_{_n}), obtaining the inner product IP2_{R_n} of the resultant vector VT2_{R} and each vector VT2_{_n}, and comparing the obtained inner product with the threshold value IP2_{Rth} or for the VT3_{_n} by obtaining the resultant vector VT3_{R}=Σ(VT3_{_n}), obtaining the inner product IP3_{R_n} of the resultant vector VT3_{R} and each vector VT3_{_n}, and comparing the obtained inner product with the threshold value IP3_{Rth}.

In this way, the processor 50 performs the processing PR1 to exclude for each of a plurality of coordinates Q_{TW_n}. This processing PR1 allows to exclude the coordinates Q_{TW_n} acquired by false detection. The threshold value Δₜₕ₁, Δₜₕ₂, IP1ₜₕ, IP3ₜₕ, IP1_{Rth}, IP2_{Rth} or IP3_{Rth} (or coefficient α), which defines the various allowable ranges described above, is predetermined by the operator.

After the excluding processing PR1, the processor 50 performs processing PR2 that averages coordinates Q_{TW_m} (m represents number n of the coordinates Q_{TW_n} registered in the active coordinates group GRP) registered in the active coordinates group GRP. Specifically, the processor 50 obtains the average coordinates (X_{TW_0}, Y_{TW_0}, Z_{TW_0}) of the coordinates (X_{TW_m}, Y_{TW_m}, Z_{TW_m}) representing a position in the coordinates Q_{TW_m} registered in the active coordinates group GRP.

Specifically, processor 50 obtains the average coordinates (X_{TW_0}, Y_{TW_0}, Z_{TW_0}) from the equations X_{TW_0}=1/k·Σ(X_{TW_m}), Y_{TW_0}=1/k·Σ(Y_{TW_m}), and Z_{TW_0}=1/k·Σ(Z_{TW_m}). In these equations, “k” indicates the number of the coordinates Q_{TW_m} registered in the active coordinates group GRP.

Additionally, the processor 50 performs the processing PR2, which averages coordinates (W_{TW_m}, P_{TW_m}, R_{TW_m}) representing the orientation in the coordinates Q_{TW_m} registered in the active coordinates group GRP. Specifically, for the coordinates (W_{TW_m}, P_{TW_m}, R_{TW_m}) representing the orientation, the processor 50 obtains the resultant vector VT1_{R}=Σ(VT1_{_m}) of the vector VT1_{_m} and the resultant vector VT3_{R}=Σ(VT3_{_m}) of the vector VT3_{_m}, as described above.

Subsequently, the processor 50 obtains an outer product OP1 of the unit vector VT1_{R′} of the resultant vector VT1_{R} and the unit vector VT3_{R′} of the resultant vector VT3_{R}. This outer product OP1 represents a vector in the direction perpendicular to the unit vector VT1_{R′} and the unit vector VT3_{R′}. Subsequently, the processor 50 obtains a unit vector VT2_{R′} by normalizing the vector represented by the outer product OP1.

Subsequently, the processor 50 obtains an outer product OP2 of the unit vector VT2_{R′} and the unit vector VT3_{R′} and obtains the unit vector VT1_{R″} by normalizing the vector represented by the outer product OP2. Thus, the processor 50 obtains unit vectors VT1_{R″}, VT2_{R′} and VT3_{R′}.

Subsequently, the processor 50 obtains the orientation (W_{TW_0}, P_{TW_0}, R_{TW_0}) represented by these unit vectors VT1_{R″}, VT2_{R′} and VT3_{R′}. The coordinates in this orientation indicate the direction of each axis of the workpiece coordinate system C4 in the tool coordinate system C2. The x-axis direction of the workpiece coordinate system C4 is the direction of the above-described unit vector VT1_{R″}, the y-axis direction is the direction of the unit vector VT2_{R′}, and the z-axis direction is the direction of the unit vector VT3_{R′}.

Alternatively, to obtain the coordinates (W_{TW_0}, P_{TW_0}, R_{TW_0}) of the orientation, the processor 50 may obtain the unit vector VT2_{R′} of the resultant vector VT2_{R}=Σ(VT2_{_m}) of the vector VT2_{_m} together with the above-described unit vector VT1_{R′}, and obtain an outer product OP3 of the unit vector VT1_{R′} and the unit vector VT2_{R′}.

Subsequently, the processor 50 may obtain the unit vector VT3_{R′} by normalizing the vector represented by the outer product OP3, obtain an outer product OP4 of the unit vector VT3_{R′} and the unit vector VT1_{R′}, and obtain the unit vector VT2_{R″} by normalizing the vector represented by the outer product OP4. The processor 50 can obtain the coordinates (W_{TW_0}, P_{TW_0}, R_{TW_0}) of the orientation from the thus obtained unit vectors VT1_{R′}, VT2_{R″} and VT3_{R′}.

By the above-described method, the processor 50 performs the processing PR2, which averages coordinates Q_{TW_m} registered in the active coordinates group GRP. As a result, the processor 50 can acquire the coordinates Q_{TW_0} (X_{TW_0}, Y_{TW_0}, Z_{TW_0}, W_{TW_0}, P_{TW_0}, R_{TW_0}) as the teaching position data TPD₀.

These coordinates Q_{TW_0} indicate the origin position of the workpiece coordinate system C4 in the tool coordinate system C2 (X_{TW_0}, Y_{TW_0}, Z_{TW_0}) and the direction of each axis (W_{TW_0}, P_{TW_0}, R_{TW_0}). Thus, the processor 50 serves as the teaching position acquisition unit 88 and obtains one teaching position data TPD₀ (coordinates Q_{TW_0}) from the acquired plurality of coordinates Q_{TW_n} (n=1, 2, 3, 4 . . . ).

It is to be understood that even when obtaining the coordinates Q_{WT_n} (X_{WT_n}, Y_{WT_n}, Z_{WT_n}, W_{WT_n}, P_{WT_n}, R_{WT_n}) of the tool coordinate system C2 in the workpiece coordinate system C4 as the teaching position data TPDₙ, the processor 50 can obtain coordinates Q_{WT_0} (X_{WT_0}, Y_{WT_0}, Z_{WT_0}, W_{WT_0}, P_{WT_0}, R_{WT_0}) of the tool coordinate system C2 in the workpiece coordinate system C4 as new teaching position data TPD₀ by the above-described method.

Subsequently, the processor 50 uses the obtained teaching position data TPD₀ to generate an operation program OP in which the teaching position data TPD₀ (i.e., coordinates Q_{TW_0} or Q_{WT_0}) is defined as an instruction code. Thus, the processor 50 serves as an operation program generating unit 92 (FIG. 2), which generates the operation program OP.

In the actual work line, the processor 70 of the controller 16 operates the robot 12 in accordance with the operation program OP and performs the operation of gripping and picking up the workpieces W that are stacked in pieces in the container A, by the hand 30. Specifically, the processor 70 operates the vision sensor 14 to image the workpiece W in the container A and acquires the imaged image data ID_{W} (second image data) from the vision sensor 14.

Subsequently, the processor 70 acquires workpiece position data WPD_{W} (second workpiece position data) indicating the position and orientation of the workpiece W in the robot coordinate system C1 shown in the image data ID_{W}, based on the acquired image data ID_{W}, as by the workpiece position acquisition unit 84 described above. Specifically, the processor 70 arranges the workpiece model WM to match the workpiece W shown in the image data ID_{W} and sets the workpiece coordinate system C4 to the arranged workpiece model WM.

Subsequently, the processor 70 acquires the coordinates Q_{RW_W} (X_{RW_W}, Y_{RW_W}, Z_{RW_W}, W_{RW_W}, P_{RW_W}, R_{RW_W}) of the workpiece coordinate system C4 in the robot coordinate system C1 as workpiece position data WPD_{W}, by acquiring the coordinates Q_{SW_W} (X_{SW_W}, Y_{SW_W}, Z_{SW_W}, W_{SW_W}, P_{SW_W}, R_{SW_W}) of the sensor coordinate system C3 of the set workpiece coordinate system C4 and transforming the coordinates Q_{SW_W} into the robot coordinate system C1. Thus, the processor 70 acquires the workpiece position data WPD_{W} (coordinates Q_{RW_W}), which indicates the position and orientation of the workpiece W in the robot coordinate system C1.

Subsequently, based on the acquired workpiece position data WPD_{W}, and teaching position data TPD₀ defined in the operation program OP, the processor 70 determines the position and orientation of the hand 30 in the robot coordinate system C1 when gripping the workpiece W imaged by the vision sensor 14.

Specifically, the processor 70 obtains coordinates Q_{RT_0} (X_{RT_0}, Y_{RT_0}, Z_{RT_0}, W_{RT_0}, P_{RT_0}, R_{RT_0}) of the robot coordinate system C1, which has the positional relationship indicated by the teaching position data TPD₀ relative to the workpiece coordinate system C4 represented by the coordinates Q_{RW_W}, by using the coordinates Q_{RW_W} acquired as the workpiece position data WPD_{W} and the teaching position data TPD₀ (specifically, coordinates Q_{TW_0} or Q_{WT_0}). The processor 70 determines the position and orientation of the hand 30 when gripping the workpiece W in the robot coordinate system C1 by setting the tool coordinate system C2 to the obtained coordinates Q_{RT_0}.

Subsequently, the processor 70 moves the hand 30, by operating the mechanical part 42 so that the hand 30 keeping the claw parts 34 and 36 closed is arranged in the position and orientation determined by the tool coordinate system C2 set to the coordinates Q_{RT_0} Of the robot coordinate system C1. This inserts claw parts 34 and 36 into the through hole H1 of the workpiece W.

Subsequently, the processor 70 grips the large ring W2 of the workpiece W with the claw parts 34 and 36 by operating the claw part drive part 38 to open the claw parts 34 and 36. As a result, as illustrated in FIG. 5, the hand 30 is able to grip the workpiece W at the gripping position taught by the teaching position data TPD₀.

Subsequently, the processor 70 can pick up the workpiece W by operating the mechanical part 42 to evacuate the hand 30 that grips the workpiece W from the container A. Subsequently, the processor 70 performs the work of picking up the workpieces W, which are stacked in pieces in the container A, with the hand 30, by repeatedly executing the above-described sequence of operations for the respective workpieces W, which are stacked in pieces in the container A.

As described above, in the present embodiment, the processor 50 of the teaching device 18 serves as the image data acquisition unit 82, the workpiece position acquisition unit 84, the hand position acquisition unit 86, the teaching position acquisition unit 88, the robot control unit 90, and the operation program generating unit 92 to teach the position and orientation at which the robot 12 grips the workpiece W with the hand 30 in the robot coordinate system C1.

Thus, the image data acquisition unit 82, the workpiece position acquisition unit 84, the hand position acquisition unit 86, the teaching position acquisition unit 88, the robot control unit 90, and the operation program generating unit 92 constitute a device 100 (FIG. 2) of teaching the position and orientation at which the robot 12 grips the workpiece W with the hand 30. That is, in the present embodiment, the device 100 is implemented in the teaching device 18, and the processor 50 of the teaching device 18 performs the functions of the device 100.

In this device 100, the image data acquisition unit 82 acquires image data IDₙ in which the vision sensor 14 that is arranged at a known position of the control coordinate system C (robot coordinate system C1) images the workpiece W when the robot 12 grips the workpiece W with the hand 30. The workpiece position acquisition unit 84 acquires, based on the image data IDₙ, the workpiece position data WPDₙ indicating the position and orientation of the workpiece W in the control coordinate system C (robot coordinate system C1) at the time of imaging the image data IDₙ.

Additionally, the hand position acquisition unit 86 acquires hand position data HPDₙ indicating the position and orientation of the hand 30 in the control coordinate system C (robot coordinate system C1) at the time of imaging the image data IDₙ. The teaching position acquisition unit 88 acquires the teaching position data TPDₙ indicating the positional relationship between the hand 30 and the workpiece W in the control coordinate system C (tool coordinate system C2, workpiece coordinate system C4) at the time of imaging the image data IDₙ, based on the workpiece position data WPDₙ and the hand position data HPDₙ.

Thus, by acquiring the teaching position data TPDₙ, based on the image data IDₙ imaged when the hand 30 grips the workpiece W at the gripping position that the operator wants to teach, the gripping position that the operator wants to teach can be taught to the robot 12 with high accuracy.

Furthermore, in the device 100, the robot control unit 90 operates the robot 12 to repeatedly change the orientation of the hand 30 gripping the workpiece W. The image data acquisition unit 82 acquires a plurality of pieces of image data IDₙ imaged by the vision sensor 14 each time the robot control unit 90 changes the orientation of the hand 30. In addition, the workpiece position acquisition unit 84 acquires the workpiece position data WPDₙ based on each image data IDₙ, and the hand position acquisition unit 86 acquires the hand position data HPDₙ at the time of imaging each image data IDₙ.

Subsequently, the teaching position acquisition unit 88 acquires the teaching position data TPDₙ at the time of imaging each piece of image data IDₙ based on the corresponding workpiece position data WPDₙ and the corresponding hand position data HPDₙ. By collecting a plurality of pieces of teaching position data TPDₙ based on pieces of the image data IDₙ of the workpiece W in various orientations in this way, the gripping position of the workpiece W can be taught to the robot 12 with higher accuracy.

Additionally, in the device 100, the teaching position acquisition unit 88 obtains new teaching position data TPD₀, which is to be used for the operation to cause the robot 12 to grip the workpiece W with the hand 30, based on the plurality of pieces of teaching position data TPDₙ. Thus, by obtaining the teaching position data TPD₀ from the plurality of pieces of teaching position data TPDₙ corresponding to pieces of the image data IDₙ of the workpiece W in various orientations, the position and orientation of the hand 30 at the time of gripping each of the workpieces W in various orientations can be determined with higher accuracy by the teaching position data TPD₀.

In the device 100, the teaching position data TPDₙ is represented as the coordinates Q_{TW_n}, Q_{WT_n} of the control coordinate system C (tool coordinate system C2, workpiece coordinate system C4).

The teaching position acquisition unit 88 obtains new teaching position data TPD₀ by excluding coordinates that are outside of the predetermined allowable range among the coordinates Q_{TW_n}, Q_{WT_n} of the plurality of pieces of teaching position data TPDₙ and obtaining the average of the coordinates Q_{TW_m}, Q_{WT_m}.

According to this configuration, coordinates Q_{TW_n}, Q_{WT_n} acquired by false detection or the like can be excluded, and by averaging the coordinates Q_{TW_m}, Q_{WT_m}, more accurate teaching position data TPD₀ can be obtained. Thus, the position and orientation of the hand 30 at the time of gripping each of the workpieces W in various orientations can be determined with higher accuracy. In the device 100, the operation program generating unit 92 generates the operation program OP in which the teaching position data TPD₀ is defined. With this configuration, the operation program OP that defines the teaching position data TPD₀ acquired as described above can be generated automatically.

In the device 100, the workpiece position acquisition unit 84 acquires, as workpiece position data WPDₙ, data indicating the position and orientation of the workpiece model WM in the control coordinate system C (robot coordinate system C2) when the workpiece model WM is matched to the workpiece W (three-dimensional point cloud image) shown in the image data IDₙ. With this configuration, the workpiece position data WPDₙ can be detected with high accuracy from the image data IDₙ imaged by the vision sensor 14.

Furthermore, in the device 100, the control coordinate system C includes the robot coordinate system C1, the workpiece coordinate system C4, the tool coordinate system C2 whose positional relationship with the robot coordinate system C1 is known, and the sensor coordinate system C3 whose positional relationship with the robot coordinate system C1 is known. The vision sensor 14 is disposed at a known position in the robot coordinate system C1.

Subsequently, the workpiece position acquisition unit 84 acquires the first coordinates Q_{SW_n} of the workpiece coordinate system C4 in the sensor coordinate system C3, which indicates the position and orientation of the workpiece W shown in the image data IDₙ, and transforms the first coordinates Q_{SW_n} into the robot coordinate system C1, thereby acquiring the second coordinates Q_{RW_n} of the workpiece coordinate system C4 in the robot coordinate system C1 as the workpiece position data WPDₙ.

In addition, the hand position acquisition unit 86 acquires the third coordinates Q_{RT_n} of the tool coordinate system C2 in the robot coordinate system C1 indicating the position and orientation of the hand 30 as the hand position data HPDₙ. The teaching position acquisition unit 88 acquires the teaching position data TPDₙ, as the coordinates Q_{TW_n} of the workpiece coordinate system C4 in the tool coordinate system C2, or as the coordinates Q_{WT_n} of the tool coordinate system C2 in the workpiece coordinate system C4, based on the second coordinates Q_{RW_n} and the third coordinates Q_{RT_n}. According to this configuration, the teaching position data TPDₙ can be acquired as the coordinates Q_{TW_n} or Q_{WT_n} in the control coordinate system C, based on the robot coordinate system C1, the tool coordinate system C2, the sensor coordinate system C3, and the workpiece coordinate system C4, which are used as the control coordinate system C.

In the above-described embodiment, the operator manually operates the teaching device 18 to change the orientation of the hand 30 that grips the workpiece W. However, without being limited to this, the processor 50 may automatically perform a series of operations such as changing the orientation of the hand 30, acquiring the image data IDₙ, acquiring the workpiece position data WPDₙ, acquiring the hand position data HPDₙ, and acquiring the teaching position data TPDₙ.

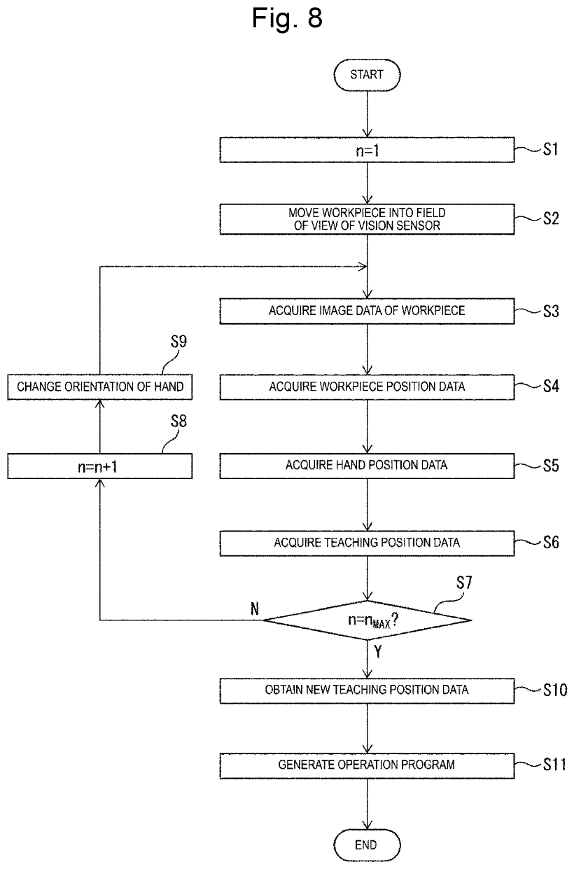

Such an embodiment will be described below with reference to FIG. 8. The flow illustrated in FIG. 8 is started when the processor 50 of the teaching device 18 accepts a teaching start command CM. For example, when the operator operates the input device 58 of the teaching device 18 to cause the hand 30 to grip the workpiece W as illustrated in FIG. 5, the operator inputs the teaching start command CM into the teaching device 18.

In step S1, the processor 50 sets the number “n”, which defines the number of pieces of teaching position data TPDₙ to be acquired, to “1”. This number “n” corresponds to “n” of the image data IDₙ, the workpiece position data WPDₙ, the hand position data HPDₙ, and the teaching position data TPDₙ described above.

In step S2, the processor 50 operates the mechanical part 42 of the robot 12 to move the workpiece W gripped by the hand 30 so as to be within the field of view of the vision sensor 14. As an example, the processor 50 may move the hand 30 along a predetermined movement path. This movement path can be defined by teaching the robot 12 in advance by the operator. As another example, the processor 50 may acquire coordinates of tool coordinate system C2 and sensor coordinate system C3 in the robot coordinate system C1 and move the hand 30 based on the coordinates.

In step S3, the processor 50 serves as the image data acquisition unit 82 to acquire the image data IDₙ. Specifically, the processor 50 sends an imaging command to the vision sensor 14 and operates the vision sensor 14 to image the image data IDₙ of the workpiece W gripped by the hand 30. Subsequently, the processor 50 serves as the image data acquisition unit 82 to acquire the image data IDₙ from the vision sensor 14.

In step S4, the processor 50 serves as the workpiece position acquisition unit 84 to acquire the workpiece position data WPDₙ(e.g., coordinates Q_{RW_n}) based on the image data IDₙ acquired in the most recent step S3 by the above-described method. In step S5, the processor 50 serves as the hand position acquisition unit 86 to acquire the hand position data HPDₙ(e.g., coordinates Q_{RT_n}) at the time of imaging the image data IDₙ acquired in the most recent step S3 by the above-described method.

In step S6, the processor 50 serves as the teaching position acquisition unit 88 to acquire the teaching position data TPDₙ(e.g., coordinates Q_{TW_n} or Q_{WT_n}) based on the workpiece position data WPDₙ acquired in the most recent step S4 and the hand position data HPDₙ acquired in the most recent step S5 by the above-described method.

In step S7, the processor 50 determines whether or not the number “n” has reached a predetermined number n_{MAX} (n=n_{MAX}). This number n_{MAX} can be predetermined by the operator. When n=n_{MAX}, the processor 50 determines YES and proceeds to step S10, while when n<n_{MAX}, determines NO and proceeds to step S8. In step S8, the processor 50 increments the number “n” by “1” (n=n+1).

In step S9, the processor 50 serves as the robot control unit 90 to operate the mechanical part 42 of the robot 12 to change the orientation of the hand 30 gripping the workpiece W. Specifically, the processor 50 rotates the hand 30 around the x-axis, y-axis, or z-axis of the tool coordinate system C2, which is set in the robot coordinate system C1 at this point, by a predetermined angle θ.

Alternatively, the processor 50 rotates the hand 30 around the x-axis, y-axis, (i.e., axis B of the workpiece W) or z-axis of the workpiece coordinate system C4, which is set in the robot coordinate system C1 at this point, by an angle θ. The angle θ and direction in which the hand 30 is rotated when this step S9 is performed may be predetermined by the operator. Alternatively, the processor 50 may automatically (e.g., randomly) determine each time this step S9 is performed such that the whole of the workpiece W is in the position to come within the field of view of the vision sensor 14, by taking into account the positional relationship between the tool coordinate system C2 (or workpiece coordinate system C4) and the sensor coordinate system C3, which have been set at this point.

After step S9, the processor 50 returns to step S3 and repeats the loop of steps S3 to S9 until determining YES in step S7. Thus, the processor 50 can automatically acquire a plurality of pieces of teaching position data TPDₙ (n=1, 2, 3, 4 . . . ).

When determining YES in step S7, the processor 50 serves, in step S10, as the teaching position acquisition unit 88 to obtain new teaching position data TPD₀ (e.g., coordinates Q_{TW_0} or Q_{WT_0}) based on the plurality of pieces of teaching position data TPDₙ acquired by the above-described method.

In step S11, the processor 50 serves as the operation program generating unit 92 to generate the operation program OP in which the teaching position data TPD₀ (i.e., coordinates Q_{TW_0} or Q_{WT_0}) is defined, as in the above-described embodiment. As described above, according to the present embodiment, the processor 50 can automatically generate the operation program OP by automatically executing a series of operations of steps S1 to S11. With this configuration, the process of teaching the robot 12 the position to grip the workpiece W can be accelerated and simplified.

In the above-described step S9, the processor 50 may serve as the robot control unit 90 to change the position of the hand 30 instead of changing the orientation of the hand 30. Specifically, in step S9, the processor 50 may operate the mechanical part 42 of the robot 12 to change the position of the hand 30 by translationally moving the hand 30 by a predetermined distance δ in the direction of the x-axis, y-axis or z-axis of the tool coordinate system C2 (or workpiece coordinate system C4), which is set in the robot coordinate system C1 at this point. Here, “translational movement” can be defined as the operation for moving the hand 30 without changing the orientation of the hand 30 (i.e., the direction of each axis of the tool coordinate system C2).

Alternatively, the processor 50 may alternately perform an operation to change the orientation of the hand 30 and an operation to change the position of the hand 30 for performing each step S9, or alternatively, the processor 50 may change the position of the hand 30 together with the orientation of the hand 30 for performing each step S9.

In the above-described embodiment, the case in which the functions of the device 100 are implemented in the teaching device 18, is described. However, without being limited to this, the functions of the device 100 can also be implemented in the controller 16 (or vision sensor 14). In this case, the processor 70 (or a processor of the vision sensor 14) of controller 16 serves as the device 100 (i.e., the image data acquisition unit 82, the workpiece position acquisition unit 84, the hand position acquisition unit 86, the teaching position acquisition unit 88, the robot control unit 90, and the operation program generating unit 92).

Additionally, some of the image data acquisition unit 82, the workpiece position acquisition unit 84, the hand position acquisition unit 86, the teaching position acquisition unit 88, the robot control unit 90, and the operation program generating unit 92 may be implemented in one of the controller 16, the teaching device 18, and the vision sensor 14, while other units may be implemented in the other one of the controller 16, the teaching device 18, and the vision sensor 14.

For example, the image data acquisition unit 82 may be implemented in the vision sensor 14, the workpiece position acquisition unit 84, the hand position acquisition unit 86, and the robot control unit 90 may be implemented in the controller 16, and the teaching position acquisition unit 88 and the operation program generating unit 92 may be implemented in the teaching device 18. In this case, the processor of the vision sensor 14, the processor 70 of the controller 16, and the processor 50 of the teaching device 18 constitute the device 100.

In the above-described embodiment, the processor 50 may serve as the hand position acquisition unit 86, acquire data indicating the position and orientation of the hand 30 in the sensor coordinate system C3 based on the image data IDₙ, and acquire the hand position data HPDₙ from the data. More specifically, as illustrated in FIG. 6, the vision sensor 14 images the image data IDₙ with a view of the workpiece W and the hand 30 gripping the workpiece W.

When serving as the image data acquisition unit 82 to acquire the image data IDₙ from the vision sensor 14, the processor 50 acquires a hand model 30M which models the hand 30, together with the above-described workpiece model WM. This hand model 30M is, for example, the three-dimensional CAD model, which is stored in advance in the memory 52.

The processor 50 analyzes the three-dimensional point cloud image of the hand 30 shown in the image data IDₙ using a predetermined pattern matching parameter and arranges the hand model 30M in a simulated manner to match the hand 30 shown in the image data IDₙ. Subsequently, the processor 50 sets the tool coordinate system C2 with the positional relationship illustrated in FIG. 3 for the hand model 30M arranged in the image data IDₙ. Subsequently, the processor 50 acquires coordinates Q_{ST_n} of the set tool coordinate system C2 in the sensor coordinate system C3 and acquires the hand position data HPDₙ(coordinates Q_{RT_n}) by transforming the coordinates Q_{ST_n} into the robot coordinate system C1.

It is also possible to make the vision sensor 14 perform these functions. For example, by applying the workpiece model WM and the hand model 30M to the imaged image data IDₙ, the vision sensor 14 (specifically, the processor) may acquire the coordinates Q_{ST_n} of the tool coordinate system C2 in the sensor coordinate system C3 and the coordinates Q_{SW_n} of the workpiece coordinate system C4 in the sensor coordinate system C3 and provide them to the teaching device 18.

Alternatively, the vision sensor 14 may serve as the workpiece position acquisition unit 84 to acquire the coordinates Q_{SW_n} of the workpiece coordinate system C4 in the sensor coordinate system C3 as the workpiece position data WPDₙ and serve as the hand position acquisition unit 86 to acquire the coordinates Q_{ST_n} of the tool coordinate system C2 in the sensor coordinate system C3 as the hand position data HPDₙ.

Subsequently, the vision sensor 14 may serve as the teaching position acquisition unit 88 to acquire the teaching position data TPDₙ(e.g., coordinates Q_{TW_n} or Q_{WT_n}) based on the workpiece position data WPDₙ (coordinates Q_{SW_n}) and the hand position data HPDₙ(coordinates Q_{ST_n}). That is, in this case, the processor of the vision sensor 14 serves as the device 100.

In the above-described embodiment, the processor 50 performs the processing PR1 to exclude for each of the plurality of coordinates Q_{TW_n} or Q_{WT_n} and subsequently performs the processing PR2 to average the coordinates Q_{TW_m} or Q_{WT_m} registered in the active coordinates group GRP. However, without being limited to this, the processor 50 may execute only one of the processing PR1 for excluding and the processing PR2 for averaging, for a plurality of coordinates Q_{TW_n} or Q_{WT_n}.

For example, the processor 50 may obtain new teaching position data TPD₀ by executing the processing PR2 for averaging the acquired plurality of coordinates Q_{TW_n} or Q_{WT_n}, without performing the processing PR1 for excluding. Alternatively, the processor 50 may only perform the processing PR1 for excluding a plurality of coordinates Q_{TW_n} or Q_{WT_n} and automatically select, in accordance with predetermined conditions, one teaching position data TPD₀ from among the coordinates Q_{TW_m} or Q_{WT_m} registered in the active coordinates group GRP as a result of the processing PR1.

In the above-described embodiment, the case in which the processor 50 obtains new teaching position data TPD₀ based on the acquired plurality of pieces of teaching position data TPDₙ is described. However, without being limited to this, the processor 50 may, for example, generate image data in which the acquired plurality of pieces of teaching position data TPDₙ are displayed in list form and display them on the display device 56.

Subsequently, the operator operates the input device 58 to give the processor 50 input data to select the desired teaching position data TPD₀ from among the plurality of pieces of teaching position data TPDₙ displayed on the display device 56. On receiving the input data, the processor 50 generates the operation program OP in which teaching position data TPD₀ selected by the operator is defined.

In the above-described embodiment, the case is described in which the processor 50 acquires a plurality of pieces of teaching position data TPDₙ by repeatedly changing the orientation of the hand 30 by serving as the robot control unit 90. However, without being limited to this, the processor 50 may acquire only the above-described teaching position data TPD₁ without changing the orientation of the hand 30. In this case, the processor 50 may generate the operation program OP in which the teaching position data TPD₁ is defined. That is, the robot control unit 90 can be omitted from the device 100 in this case.

In the above-described embodiment, the case is described in which the processor 50 serves as the operation program generating unit 92 to generate the operation program OP. However, without being limited to this, the operator may manually generate the operation program OP based on the teaching position data TPDₙ acquired by the processor 50. That is, in this case, the operation program generating unit 92 can be omitted from the device 100.

In the above-described embodiment, the case is described in which the processor 50 acquires the workpiece position data WPDₙ by applying the workpiece model WM to the image data IDₙ. However, without being limited to this, the processor 50 can also acquire the workpiece position data WPDₙ by analyzing the image of the workpiece W shown in the image data IDₙ without using the workpiece model WM.

In the above-described embodiment, the case is described in which the teaching position data TPDₙ is acquired based on the robot coordinate system C1, the tool coordinate system C2, the sensor coordinate system C3, and the workpiece coordinate system C4, as the control coordinate system C. However, without being limited to this, for example, teaching position data TPDₙ can be acquired based on a world coordinate system C5. The world coordinate system C5 is the control coordinate system C that determines the three-dimensional space of a work cell and is fixedly set in the work cell.

Note that the vision sensor 14 may be fixed to the mechanical part 42 of the robot 12 (e.g., upper arm 26 or lower arm 24) instead of the retention frame 44. In this case, the vision sensor 14 is attached to the mechanical part 42 so that the workpiece W gripped by the hand 30 can be imaged. In the above-described embodiment, a case is described in which the workpiece position data WPDₙ, the hand position data HPDₙ, and the teaching position data TPDₙ are coordinates Q of the control coordinate system C, but without being limited to this, may be represented as any other data.

Furthermore, instead of gripping the large ring W2, the hand 30 may grip the small ring W3 by pressing the claw parts 34 and 36 against the inner wall surface of the through hole H2. In this case, the teaching device 18 teaches the position and orientation at which the hand 30 grips the small ring W3 using a method similar to the above-described embodiment.

The workpiece W is not limited to the form illustrated in FIG. 4 (connecting rod) but can be of any shape, and the hand 30 can be of any type. For example, instead of the claw parts 34 and 36 that can be opened and closed, the hand 30 may include, for example, a suction part (vacuum equipment, sucking disc, magnet, or the like) and suctions and grips the workpiece W with the suction part.

The vision sensor 14 may be a two-dimensional camera. In this case, the robot system 10 may further include a distance sensor that is fixed to the vision sensor 14 and can measure the distance d between the vision sensor 14 and the subject (workpiece W). The teaching device 18 may also be directly connected to the robot 12 (servo motor 40) or the vision sensor 14. As described above, the present disclosure is described above through the embodiment, but the above-described embodiment does not limit the invention according to the claims.

### REFERENCE SIGNS LIST

10 Robot system
12 Robot
14 Vision sensor
16 Controller
18 Teaching device
30 Hand
70, 100 Processor
82 Image data acquisition unit
84 Workpiece position acquisition unit
86 Hand position acquisition unit
88 Teaching position acquisition unit
90 Robot control unit
92 Operation program generating unit

1. A device configured to teach a position and orientation at which a robot grips a workpiece with a hand in a control coordinate system for controlling the robot, the device comprising:
an image data acquisition unit configured to acquire image data of the workpiece imaged by a vision sensor arranged at a known position in the control coordinate system when the robot grips the workpiece with the hand;
a workpiece position acquisition unit configured to acquire workpiece position data, which indicates a position and orientation of the workpiece in the control coordinate system when the vision sensor images the image data, based on the image data;
a hand position acquisition unit configured to acquire hand position data, which indicates a position and orientation of the hand in the control coordinate system when the vision sensor images the image data; and
a teaching position acquisition unit configured to acquire teaching position data, which indicates a positional relationship between the hand and the workpiece in the control coordinate system when the vision sensor images the image data, based on the workpiece position data and the hand position data.

2. The device of claim 1, further comprising a robot control unit configured to operate the robot so as to repeatedly change the orientation of the hand gripping the workpiece,
wherein the image data acquisition unit is configured to acquire a plurality of pieces of the image data imaged by the vision sensor every time the robot control unit changes the orientation of the hand,
wherein the workpiece position acquisition unit is configured to acquire a plurality of pieces of the workpiece position data respectively when each of the plurality of pieces of the image data is imaged, based on each of the plurality of pieces of the image data acquired by the image data acquisition unit,
wherein the hand position acquisition unit is configured to acquire a plurality of pieces of the hand position data respectively when each of the plurality of pieces of the image data is imaged, and wherein the teaching position acquisition unit is configured to acquire a plurality of pieces of the teaching position data respectively when each of the plurality of pieces of the image data is imaged, based on the respective pieces of the workpiece position data acquired by the workpiece position acquisition unit and on the respective pieces of the hand position data acquired by the hand position acquisition unit.

3. The device of claim 2, wherein the teaching position acquisition unit is configured to obtain new teaching position data to be used for an operation to cause the robot to grip the workpiece with the hand, based on the plurality of pieces of the acquired teaching position data.

4. The device of claim 3, wherein the teaching position data is represented as coordinates of the control coordinate system, and
wherein the teaching position acquisition unit is configured to obtain the new teaching position data by:
excluding the coordinates of the teaching position data, which are outside of a predetermined allowable range, among the coordinates of the plurality of pieces of the teaching position data; or
obtaining an average of the coordinates of the plurality of pieces of the teaching position data.

5. The device of claim 1, further comprising an operation program generating unit configured to generate an operation program in which the teaching position data is defined.

6. The device of claim 1, wherein the workpiece position acquisition unit is configured to acquire, as the workpiece position data, data indicating a position and orientation in the control coordinate system of a workpiece model which models the workpiece when the workpiece model is matched to the workpiece shown in the image data.

7. The device of claim 1, wherein the control coordinate system includes:
a robot coordinate system set to the robot;
a workpiece coordinate system set to the workpiece;
a tool coordinate system set to the hand and having a known positional relationship with the robot coordinate system; and
a sensor coordinate system set to the vision sensor and having a known positional relationship with the robot coordinate system,
wherein the vision sensor is arranged at the known position in the robot coordinate system,
wherein the workpiece position acquisition unit is configured to:
acquire first coordinates in the sensor coordinate system of the workpiece coordinate system indicating a position and orientation of the workpiece shown in the image data; and
acquire, as the workpiece position data, second coordinates of the workpiece coordinate system in the robot coordinate system by transforming the first coordinates into the robot coordinate system,
wherein the hand position acquisition unit is configured to acquire, as the hand position data, third coordinates in the robot coordinate system of the tool coordinate system indicating a position and orientation of the hand, and
wherein the teaching position acquisition unit is configured to acquire the teaching position data as coordinates of the workpiece coordinate system in the tool coordinate system or as coordinates of the tool coordinate system in the workpiece coordinate system, based on the second coordinates and the third coordinates.

8. A robot system comprising:
a robot including a hand configured to grip a workpiece;
a vision sensor configured to image the workpiece; and
the device of claim 1.

9. The robot system of claim 8, comprising a controller configured to control the robot so as to grip the workpiece with the hand, based on second image data of the workpiece imaged by the vision sensor, wherein the controller is configured to:
acquire, as second workpiece position data, data indicating a position and orientation in the control coordinate system of the workpiece shown in the second image data; and
determine a position and orientation of the hand in the control coordinate system when the hand grips the workpiece imaged by the vision sensor, based on the second workpiece position data and the teaching position data.

10. A method of teaching a position and orientation at which a robot grips a workpiece with a hand in a control coordinate system for controlling the robot, the method comprising:
acquiring, by a processor, image data of the workpiece imaged by a vision sensor arranged at a known position in the control coordinate system when the robot grips the workpiece with the hand;
acquiring, by the processor, workpiece position data indicating a position and orientation of the workpiece in the control coordinate system when the vision sensor images the image data, based on the image data;
acquiring, by the processor, hand position data indicating a position and orientation of the hand in the control coordinate system when the vision sensor images the image data; and
acquiring, by the processor, teaching position data indicating a positional relationship between the hand and the workpiece in the control coordinate system when the vision sensor images the image data, based on the workpiece position data and the hand position data.
